(19) United States
(12) Patent Application Publication
(10) Pub. No.: US 2026/0292434 A1
(43) Pub. Date: Sep. 24, 2026

(54) Computer System-Implemented Audio Processing Method, Playback System, and Non-transitory Computer-Readable Storage Medium Storing Program

(71) Applicant: Yamaha Corporation, Hamamatsu-shi (JP)

(72) Inventor: Yusuke KONAGAI, Hamamatsu-shi (JP)

(21) Appl. No.: 19/573,615

(22) Filed: Mar. 20, 2026

(30) Foreign Application Priority Data
Mar. 24, 2025 (JP) 2025-048093

(51) Int. Cl. H04S 7/00

(52) U.S. Cl. CPC H04S 7/303; H04S 7/40

(57) ABSTRACT

A computer system-implemented audio processing method includes acquiring two or more audio signals. The method also includes performing a localization process on the two or more audio signals to create two or more playback signals. The localization process includes localizing sound images from a plurality of virtual speakers including a first virtual speaker located in a front left direction from a listening point for a listener and a second virtual speaker located in a front right direction from the listening point. Localizing the sound images includes setting a localization angle formed about the listening point between the first virtual speaker and the second virtual speaker to one of different angles in the localization process.

### CROSS-REFERENCE TO RELATED APPLICATION

The present application claims priority under 35 U.S.C. §119 to Japanese Patent Application No. 2025-048093, filed Mar. 24, 2025, the contents of which are incorporated herein by reference in their entirety.

### BACKGROUND

The present disclosure relates to a computer system-implemented audio processing method, a playback system, and a non-transitory computer-readable storage medium storing a program.

Different types of techniques to control the sound field being perceived by a person listening to sound using a sound emission device such as, for example, a headphone or an earphone have been proposed in the past. For instance, JP 3687099 B2 discloses playing back audio signals using an audio signal playback means worn on a listener’s head, in such a way that localizes played-back sound images in the direction of the video played back by an image signal playback means.

However, in reality, merely having sound images localized in the direction of the video can hardly establish a sound field that is optimal for a listener. In view of the foregoing, an object of at least one aspect of the present disclosure is to establish a sound field that is optimal for a listener.

### SUMMARY

One aspect is a computer system-implemented audio processing method that includes acquiring two or more audio signals. The method also includes subjecting the two or more audio signals to a localization process to create two or more playback signals. The localization process includes localizing sound images from a plurality of virtual speakers including a first virtual speaker located in a front left direction from a listening point for a listener and a second virtual speaker located in a front right direction from the listening point. The localizing the sound images includes setting a localization angle formed about the listening point between the first virtual speaker and the second virtual speaker to one of different angles in the localization process.

Another aspect is a playback system that includes a circuitry configured to acquire two or more audio signals. The circuitry is also configured to perform audio processing. The audio processing includes subjecting the two or more audio signals to a localization process to create two or more playback signals. The localization process includes localizing a plurality of virtual speakers including a first virtual speaker located in a front left direction from a listening point for a listener and a second virtual speaker located in a front right direction from the listening point. The circuitry is also configured to perform sound field control. The sound field control includes setting a localization angle formed about the listening point between the first virtual speaker and the second virtual speaker to one of different angles in the localization process.

Another aspect is a non-transitory computer-readable storage medium storing a program executable by at least one processor of a computer system. When executed by the at least one processor, the program causes the at least one processor to carry out a method that includes acquiring two or more audio signals. The method also includes performing audio processing. The audio processing includes subjecting the two or more audio signals to a localization process to create two or more playback signals. The localization process includes localizing a plurality of virtual speakers including a first virtual speaker located in a front left direction from a listening point for a listener and a second virtual speaker located in a front right direction from the listening point. The method also includes performing sound field control. The sound field control includes setting a localization angle formed about the listening point between the first virtual speaker and the second virtual speaker to one of different angles in the localization process.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram illustrating an example configuration of a playback system in accordance with an embodiment;

FIG. 2 is a block diagram illustrating example components of an audio output device;

FIG. 3 is a block diagram illustrating example functional circuits of the audio output device;

FIG. 4 illustrates a sound field in a first state that may be achieved by a localization process;

FIG. 5 illustrates a sound field in a second state that may be achieved by the localization process;

FIG. 6 is a flowchart of an example procedure of a sound field control process;

FIG. 7 is a block diagram illustrating example functional circuits of an audio output device in accordance with another embodiment;

FIG. 8 is a flowchart of a sound field control process in accordance with the embodiment of FIG. 7;

FIG. 9 is a block diagram illustrating an example configuration of an audio output device in accordance with yet another embodiment;

FIG. 10 is a block diagram illustrating example functional circuits of an audio output device in accordance with yet another embodiment;

FIG. 11 is a flowchart of a sound field control process in accordance with the embodiment of FIG. 10;

FIG. 12 illustrates a sound field in a first state that may be achieved in accordance with yet another embodiment;

FIG. 13 illustrates a sound field in a second state that may be achieved in accordance with the embodiment of FIG. 12; and

FIG. 14 is a block diagram of a playback system in accordance with a variant embodiment.

### DETAILED DESCRIPTION

The present specification is applicable to a computer system-implemented audio processing method, a playback system, and a non-transitory computer-readable storage medium storing a program.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral.

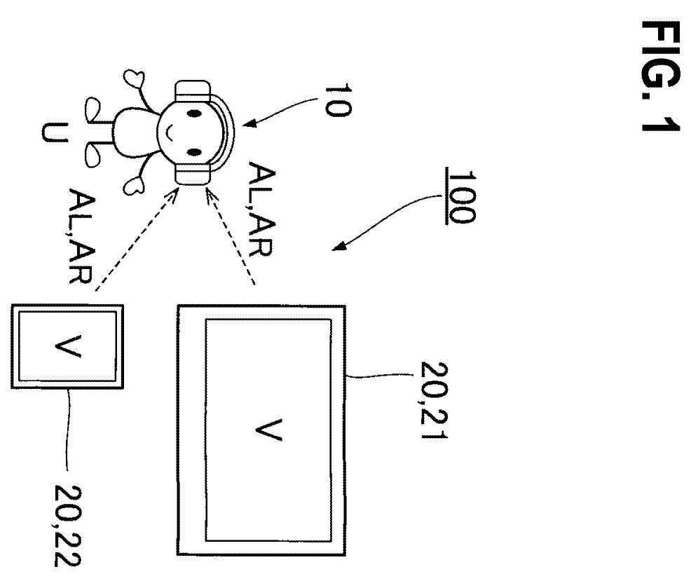

FIG. 1 is a block diagram illustrating an example configuration of a playback system 100 in accordance with an embodiment of the present disclosure. The playback system 100 provides an audio/visual (AV) system that plays back a piece of moving image content composed of video and sound. A user U is a listener and viewer of the piece of moving image content. The playback system 100 includes an audio output device 10 and a display apparatus 20 (or display elements 21 and 22).

The piece of moving image content may be a piece of content for viewing purposes represented by a video signal V and an audio signal A. The video signal V represents video in the piece of moving image content. The display apparatus 20 displays the video represented by the video signal V for the piece of moving image content. Examples of the display apparatus 20 include a liquid crystal panel, an organic electro-luminescence (EL) panel, and other more such display panels. For instance, the display apparatus 20 (or display elements 21 and 22) may receive a piece of moving image content distributed from a distribution server over, for example, the Internet or other such telecommunication network to display the video represented by the video signal V for the piece of moving image content.

The user U may be allowed to select one of the display element 21 or the display element 22 for use as the display apparatus 20 to play back the piece of moving image content. The display element 21 may be a large-screen display appliance such as, for example, a television receiver. The display element 22 may be a small-size display component built in a portable terminal such as, for example, a smartphone or a tablet computer. It should be recognized that the display element 21 and the display element 22 can play back the same piece of moving image content or different pieces of moving image content.

The display size of the display element 21 is different from the display size of the display element 22. A display size denotes the size of a screen (or, for example, the size of a display area) on which video is displayed using the video signal V. More specifically, the display size of the display element 21 is greater than the display size of the display element 22. For example, the display size of the display element 21 is 17 inches or more, and the size of the display element 22 is less than 17 inches.

The audio signal A represents sound in the piece of moving image content. For instance, the audio signal A may represent a variety of types of sound such as voice, music, and sound effect. The audio signal A may be in the form of a left-and-right two-channel signal, which includes a left-channel audio signal component AL and a right-channel audio signal component AR. Note, however, that the audio signal A may contain components from more than two channels or contain a single component from a single channel. For instance, the audio signal A can be in the form of a multi-channel signal such as a 5.1 channel or 7.1 channel signal. The display apparatus 20 (or display elements 21 and 22) transmits the audio signal A (or audio signal components AL and AR) for the piece of moving image content, as received from the distribution server, to the audio output device 10 through cabled or wireless communication.

The audio output device 10 outputs sound for the piece of moving image content, as represented by the audio signal A. The audio output device 10 is worn on the head of the user U. In particular, a headphone and earphones to be worn on the two ears of the user U are some of the illustrative examples of the audio output device 10. The audio output device 10 plays back sound for the piece of moving image content in parallel to the playback of video by the display apparatus 20 for the piece of moving image content. The user U listens to the sound played back by the audio output device 10 for the piece of moving image content while viewing the video displayed by the display apparatus 20 for the piece of moving image content. As is clear from the foregoing, the video signal V and the audio signal A are meant to be paired with each other. More specifically, the video signal V and the audio signal A are played back in a parallel relationship to each other.

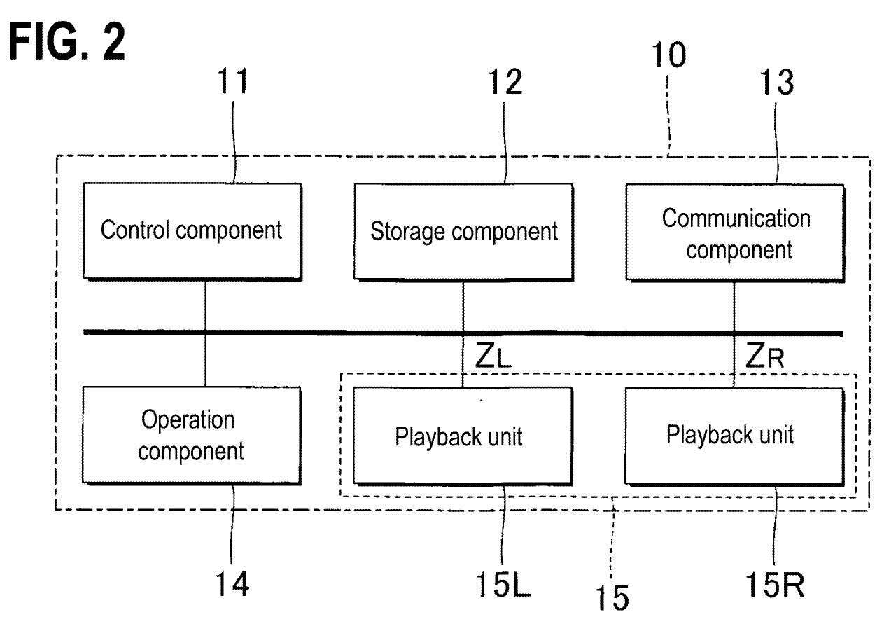

FIG. 2 is a block diagram illustrating example components of the audio output device 10. The audio output device 10 includes a control component 11, a storage component 12, a communication component 13, an operation component 14, and a sound emission component 15.

The communication component 13 is where communication with the display apparatus 20 (or the display element 21 or display element 22) takes place. More specifically, the communication component 13 receives an audio signal component AL and an audio signal component AR, which are transmitted from the display apparatus 20. It should be noted that communication between the display apparatus 20 and the communication component 13 takes place through either cabled communication using a connection cable (not shown) or wireless communication relying on, for example, Bluetooth (registered trademark).

The control component 11 is implemented by a single processor or several processors designed to control various circuits of the sound emission component 15. By way of example, the control component 11 is implemented by one or more processor types selected from, for example, a central processing unit (CPU), a graphics processing unit (GPU), a sound processing unit (SPU), a digital signal processor (DSP), a field programmable gate array (FPGA), and an application specific integrated circuit (ASIC).

Ine one example, the control component 11 subjects the audio signal A (or audio signal components AL and AR) received at the communication component 13 to audio processing designed to create a playback signal Z. The playback signal Z represents sound for the piece of moving image content. More specifically, the playback signal Z is in the form of a left-and-right two-channel signal, which includes a left-channel playback signal component ZL and a right-channel playback signal component ZR.

The storage component 12 is in the form of a single memory or several memories storing a program to be executed by the control component 11 and a variety of data to be used by the control component 11. For instance, the storage component 12 is constituted by a magnetic recording medium, a semiconductor recording medium, and/or other such known recording medium. The storage component 12 can be constituted by a combination of more than one storage medium types. Also, a portable recording medium that can be removably attached to the sound emission component 15 may be used as the storage component 12.

The operation component 14 provides an input device for receiving a specification from the user U. Examples of the operation component 14 include an operator that can be operated by the user U, and a touch-sensitive panel that senses contact with the user U. It should be recognized that an operation component 14 forming a separate entity from the audio output device 10 can be linked to the audio output device 10 through cabled or wireless communication. For instance, a portable terminal such as a smartphone or a tablet computer may be linked to the audio output device 10 through cabled or wireless communication and, as a result, may be used as the operation component 14.

The user U can operate the operation component 14 to provide, to the audio output device 10, a specification of which one of the display element 21 or display element 22 is to be used to display video for the piece of moving image content. For instance, when the user U wishes to display video for the piece of moving image content on the display element 21, the user U uses the operation component 14 to select the display element 21, and when the user U wishes to display video for the piece of moving image content on the display element 22, the user U uses the operation component 14 to select the display element 22.

The sound emission component 15 plays back sound for the piece of moving image content, as represented by the playback signal Z (or playback signal components ZL and ZR). The sound emission component 15 includes a left-channel playback unit 15L and a right-channel playback unit 15R. The playback unit 15L is worn on the left ear of the user U to play back sound represented by the left-channel playback signal component ZL. The playback unit 15R is worn on the right ear of the user U to play back sound represented by the right-channel playback signal component ZR. It should be appreciated that, for the purpose of illustration, a digital-to-analog converter for converting the playback signal Z from digital to analog and an amplifier for amplifying the playback signal Z are omitted from the figures.

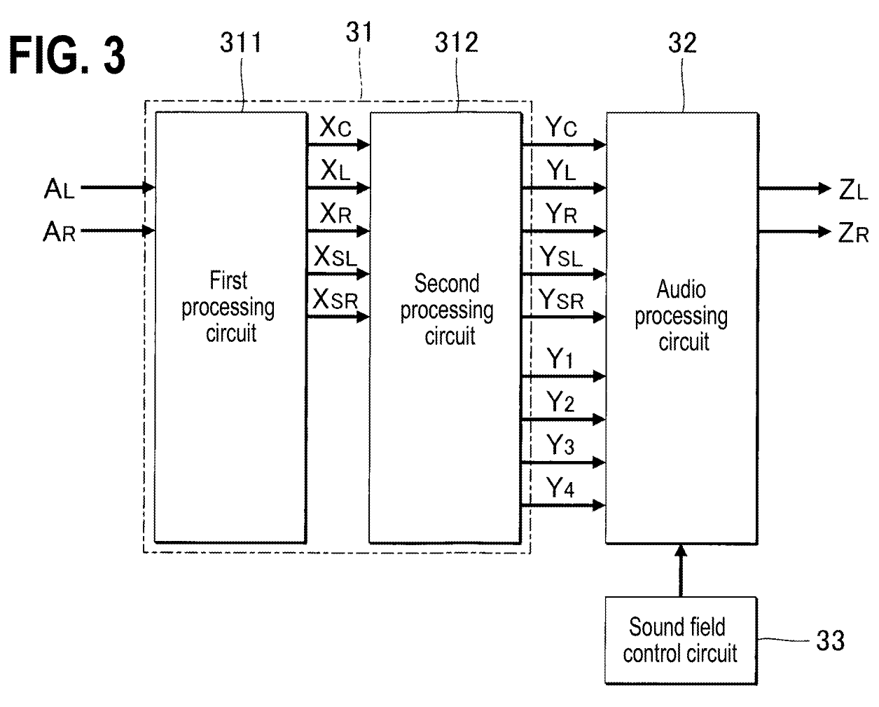

FIG. 3 is a block diagram illustrating example functional circuits of the audio output device 10. The control component 11 executes the program stored in the storage component 12 to implement a plurality of functions (or a signal acquisition circuit 31, an audio processing circuit 32, and a sound field control circuit 33) for creating the playback signal Z (or playback signal components ZL and ZR) from the audio signal A (or audio signal components AL and AR). It should be understood that the playback signal component ZL and the playback signal component ZR serve as one of the illustrative examples of “two or more playback signals”.

The signal acquisition circuit 31 subjects the audio signal A received at the communication component 13 to audio processing designed to create a plurality of audio signals Y (or audio signal components YC, YL, YR, YSL, YSR, and Y1 to Y4). It should be understood that the audio signals Y (or audio signal components YC, YL, YR, YSL, YSR, and Y1 to Y4) serve as one of the illustrative examples of “two or more audio signals”. The signal acquisition circuit 31 includes a first processing circuit 311 and a second processing circuit 312.

The first processing circuit 311 creates a surround five-channel audio signal X (or audio signal components XC, XL, XR, XSL, and XSR) from the left-and-right two-channel audio signal A (or audio signal components AL and AR). More specifically, the first processing circuit 311 subjects the audio signal A to first processing to create a five-channel audio signal X. For instance, the first processing involves an up-mixing process for increasing the total number of channels.

The audio signal component XC is a central channel (C) signal component, which is assigned to a front direction from the listener. The audio signal component XL is a front left channel (L) signal component, which is assigned to a front left direction from the listener, and the audio signal component XR is a front right channel (R) signal component, which is assigned to a front right direction from the listener. The audio signal component XSL is a lateral left channel (SL) signal component, which is assigned to a lateral left direction from the listener, and the audio signal component XSR is a lateral right channel (SR) signal component, which is assigned to a lateral right direction from the listener. It should be noted that the first processing circuit 311 may be omitted if the audio signal X (or audio signal components XC, XL, XR, XSL, and XSR) is directly provided to the audio output device 10.

The second processing circuit 312 creates a several-channel audio signal Y (or audio signal components YC, YL, YR, YSL, YSR, and Y1 to Y4) from the audio signal X (or audio signal components XC, XL, XR, XSL, and XSR) provided by the first processing circuit 311. More specifically, the second processing circuit 312 subjects the audio signal X to second processing designed to create the audio signal Y. For instance, the second processing involves a reverberation process to incorporate one or more reverberation components that would be expected in an acoustically designed environment such as an auditorium.

The audio signal component YC is a central channel (C) signal component, which is assigned to a front direction from the listener. The audio signal component YL is a front left channel (L) signal component, which is assigned to a front left direction from the listener, and the audio signal component YR is a front right channel (R) signal component, which is assigned to a front right direction from the listener. The audio signal component YSL is a lateral left channel (SL) signal component, which is assigned to a lateral left direction from the listener, and the audio signal component YSR is a lateral right channel (SR) signal component, which is assigned to a lateral right direction from the listener. In addition, the audio signal components Y1 to Y4 represent, for example, reverberation sound that is meant to be paired with the audio signal X.

The audio processing circuit 32 subjects the audio signal Y provided by the signal acquisition circuit 31 to audio processing designed to create the left-and-right two-channel playback signal Z (or playback signal components ZL and ZR). The audio processing performed by the audio processing circuit 32 involves a process that will hereinafter be referred to as a “localization process”, to control a sound field to be perceived by the user U upon listening to sound being played back from the sound emission component 15.

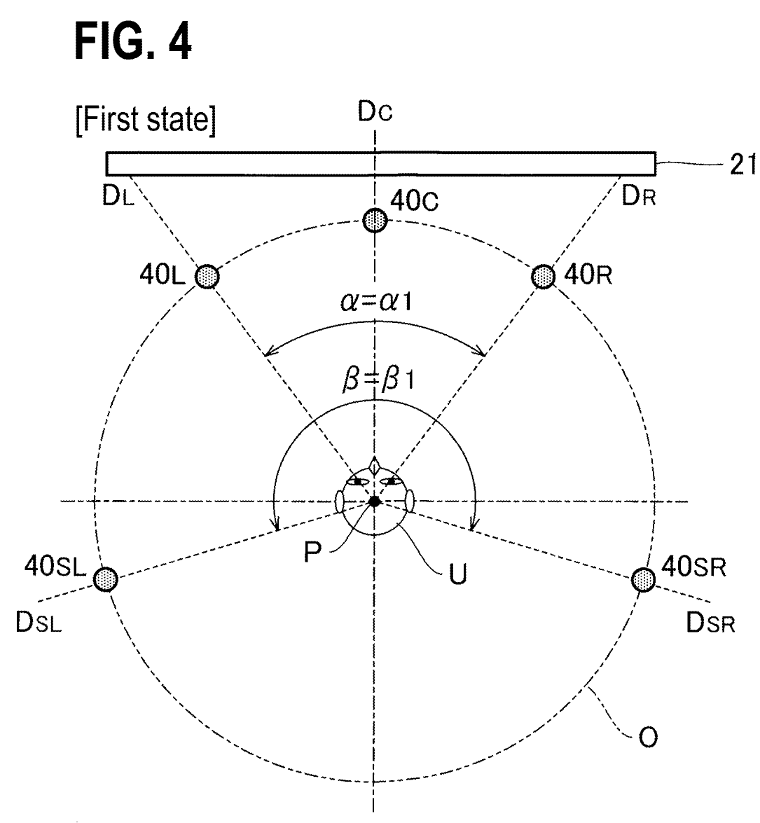

FIG. 4 illustrates the localization process. A listening point P in FIG. 4 denotes a point where sound being played back from the sound emission device 15 is listened to. For instance, a representative point in or on the user U serves as one of the illustrative examples of the listening point P.

The localization process includes localizing sound images from a plurality of virtual speakers 40 (or virtual speakers 40C, 40L, 40R, 40SL, and 40SR) about the listening point P. The virtual speakers 40 are each an imaginary speaker that is perceived by the user U as if it were a sound source by which sound represented by the playback signal Z is being played back and emitted.

Still referring to FIG. 4, the sound image from the virtual speaker 40C is localized in the direction DC of the exact front side of the user U as viewed from the listening point P. The sound image from the virtual speaker 40L is localized in the direction of the front left side of the listening point P, and the sound image from the virtual speaker 40R is localized in the direction of the front right side of the listening point P. Further, the sound image from the virtual speaker 40SL is localized in the direction of the lateral left side (or rear left side) of the listening point P, and the sound image from the virtual speaker 40SR is localized in the direction of the lateral right side (or rear right side) of the listening point P. The plurality of virtual speakers 40 (or virtual speakers 40C, 40L, 40R, 40SL, and 40SR) are positioned along the circumference of an imaginary circle O enclosing the listening point P. By way of example, the imaginary circle O is a perfect circle centered about the listening point P or an ellipse having a major axis passing through the listening point P. It should be understood that the virtual speaker 40L serves as one of the illustrative examples of a “first virtual speaker”, and the virtual speaker 40R serves as one of the illustrative examples of a “second virtual speaker”. Further, the virtual speaker 40SL serves as one of the illustrative examples of a “third virtual speaker”, and the virtual speaker 40SR serves as one of the illustrative examples of a “fourth virtual speaker”.

The localization process includes performing a convolution of the audio signal Y with a predefined head-related impulse response (HRIR) function to create the playback signal component ZL and the playback signal component ZR. Any known convolution technique can be used for the convolution with the head-related impulse response function. The audio processing circuit 32 can switch between head-related impulse response functions for use in the localization process. This way, the positions, at which the virtual speakers 40 are localized relative to the listening point P, can be controlled to varying positions.

The sound field control circuit 33 controls the sound field to be realized by the playback signal Z. That is, the sound field control circuit 33 manages the positions, at which the sound images from the virtual speakers 40 are to be localized in the localization process. More specifically, the sound field control circuit 33 selectively controls the sound field to be perceived by the user U upon listening to the sound being played back according to the playback signal Z to either a first state or a second state. The first state and the second state differ in the positions at which the sound images from the virtual speakers 40 are localized.

For instance, two or more head-related impulse response functions corresponding to different sound fields are stored in the storage component 12. The sound field control circuit 33 selects a head-related impulse response function associated with the first state from among the two or more head-related impulse response functions as a head-related impulse response function to be used by the audio processing circuit 32 in the localization process to control the sound field of the sound being played back to the first state. Further, the sound field control circuit 33 selects a head-related impulse response function associated with the second state from among the two or more head-related impulse response functions as a head-related impulse response function to be used by the audio processing circuit 32 in the localization process to control the sound field of the sound being played back to the second state.

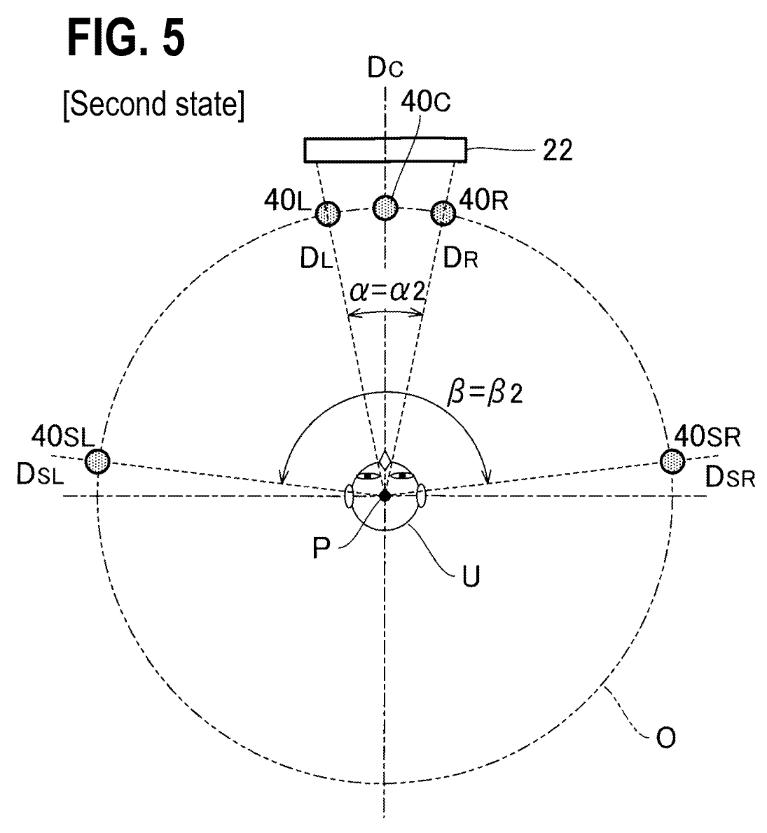

The example state depicted in FIG. 4 is the first state. FIG. 5 schematically shows the second state. Referring to FIGS. 4 and 5, the angle formed about the listening point P between the virtual speaker 40L and the virtual speaker 40R is defined as a localization angle α. More specifically, the angle situated between the direction DL of the virtual speaker 40L as viewed from the listening point P and the direction DR of the virtual speaker 40R as viewed from the listening point P and spanning a range containing the direction DC of the exact front side for the listening point P is defined as the localization angle α.

Still referring to FIGS. 4 and 5, the angle formed between the virtual speaker 40SL and the virtual speaker 40SR about the listening point P is defined as a localization angle β. More specifically, the angle situated between the direction DSL of the virtual speaker 40SL as viewed from the listening point P and the direction DSR of the virtual speaker 40SR as viewed from the listening point P and spanning a range containing the direction DC of the exact front side for the listening point P is defined as the localization angle β.

In the example shown in FIG. 4, in the first state, the localization angle α between the virtual speaker 40L and the virtual speaker 40R is set to an angle α1. Further, in the first state, the localization angle β between the virtual speaker 40SL and the virtual speaker 40SR is set to an angle β1. It should be understood that the angle α1 serves as an example of a “first angle”.

Meanwhile, in the example shown in FIG. 5, in the second state, the localization angle α formed between the virtual speaker 40L and the virtual speaker 40R is set to an angle α2, with the angle α2 being smaller than the angle α1 (where α2 < α1). Further, in the second state, the localization angle β between the virtual speaker 40SL and the virtual speaker 40SR is set to an angle β2, with the angle β2 being smaller than the angle β1 (where β2 < β1). It should be understood that the angle α2 serves as an example of a “second angle”.

As is clear from the foregoing, the localization angle α formed about the listening point P between the virtual speaker 40L and the virtual speaker 40R can be set to one of different angles (or angles α1 and α2). Likewise, the localization angle β formed about the listening point P between the virtual speaker 40SL and the virtual speaker 40SR can be set to one of different angles (or angles β1 and β2). Each of the localization angle α and the localization angle β is controlled in dependence on the other. That is, in the localization process, the positions of the virtual speaker 40SL and the virtual speaker 40SR (or the localization angle β) can change as a function of a change in localization angle α formed between the virtual speaker 40L and the virtual speaker 40R.

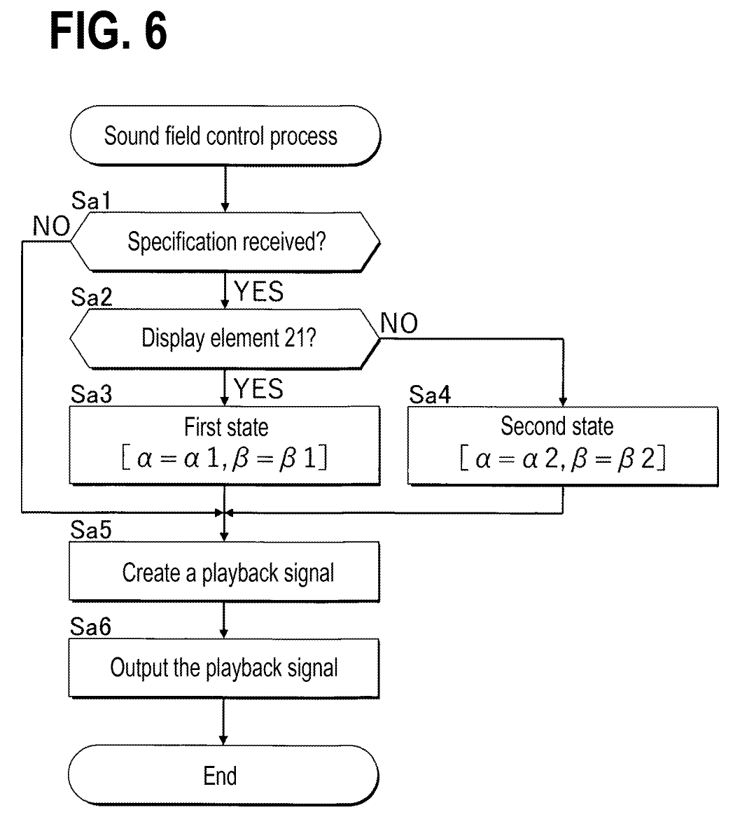

FIG. 6 is a flowchart of an example particular procedure of processing that is implemented by the control component 11 and that will hereinafter be referred to as a “sound field control process”. By way of example, an initial round of the sound field control process begins in response to the operation on the operation component 14 by the user U, and subsequent rounds of the sound field control process are iterated at predetermined intervals. It should be noted that the creation of the audio signal Y in the signal acquisition circuit 31 takes place in parallel to the sound field control process.

Once the sound field control process begins, the control component 11 checks if a specification of which appliance (or, namely, the display element 21 or the display element 22) to play back video for the piece of moving image content has been received from the user U (at step Sa1). If the specification of a player appliance has been received (YES at step Sa1), the control component 11 checks if the player appliance specified by the user U is the display element 21 with the greater display size (at step Sa2).

If the display element 21 has been specified by the user U (YES at step Sa2), the control component 11 (or the sound field control circuit 33) tells the audio processing circuit 32 to enforce the first state exemplarily depicted in FIG. 4 (at step Sa3). That is, the control component 11 sets the localization angle α between the virtual speaker 40L and the virtual speaker 40R to the angle α1 and sets the localization angle β between the virtual speaker 40SL and the virtual speaker 40SR to the angle β1.

Meanwhile, if the display element 22 with the smaller display size has been specified by the user U (NO at step Sa2), the control component 11 (or the sound field control circuit 33) tells the audio processing circuit 32 to enforce the second state exemplarily depicted in FIG. 5 (at step Sa4). That is, the control component 11 sets the localization angle α between the virtual speaker 40L and the virtual speaker 40R to the angle α2 and sets the localization angle β between the virtual speaker 40SL and the virtual speaker 40SR to the angle β2. As is clear from the foregoing, the control component 11 (or the sound field control circuit 33) sets the localization angle α and the localization angle β according to the specification from the user U.

The control component 11 (or the audio processing circuit 32) performs the localization process with the localization angle α and the localization angle β being set in the above fashion, to create the playback signal Z (or playback signal components ZL and ZR) (at step Sa5). The control component 11 (or the audio processing circuit 32) feeds the playback signal Z (or playback signal components ZL and ZR) to the sound emission component 15 (at step Sa6). More specifically, the playback signal component ZL is fed to the playback unit 15L, and the playback signal component ZR is fed to the playback unit 15R.

In contrast, if the specification of a player appliance has not been received from the user U (NO at step Sa1), the control component 11 does not change the localization angle α or the localization angle β (at steps Sa3 and Sa4). That is, the sound field of the sound being played back according to the playback signal Z is kept in whichever of the first and second states is the initially set state or kept in the state brought about by the most recent change.

As a result of the implementation of the example sound field control process depicted above, the sound field of the sound being played back according to the playback signal Z is set to the first state in the case of the video for the piece of moving image content being displayed on the display element 21 with the greater display size. Meanwhile, the sound field of the sound being played back according to the playback signal Z is set to the second state in the case of the video for the piece of moving image content being displayed on the display element 22 with the smaller display size. That is, the localization angle α in the case of the video being displayed on the display element 21 (when equal to the angle α1) is greater than the localization angle α in the case of the video being displayed on the display element 22 (when equal to the angle α2). Further, the localization angle β in the case of the video being displayed on the display element 21 (when equal to the angle β1) is greater than the localization angle β in the case of the video being displayed on the display element 22 (when equal to the angle β2).

As is clear from the foregoing, in the instant embodiment, the localization angle α formed about the listening point P between the virtual speaker 40L and the virtual speaker 40R is set to one of different angles (or, namely, the angle α1 or angle α2). For this reason, in comparison to when the localization angle α is fixed, a sound field that is optimal for a user U can be established. In particular, in the instant embodiment, the localization angle α and the localization angle β are set according to a specification from the user U. Therefore, a sound field that matches the preference of an individual user U can be established.

Further, in the instant embodiment, the positions of the virtual speaker 40SL and the virtual speaker 40SR (or, more particularly, the localization angle β) are controlled in dependence on the localization angle α between the virtual speaker 40L and the virtual speaker 40R. For this reason, the overall sound field containing the virtual speaker 40SL and the virtual speaker 40SR in addition to the virtual speaker 40L and the virtual speaker 40R can be controlled to achieve an optimal sound field for a user U.

Another embodiment according to the present disclosure will be described. In the following discussions on different example embodiments, those elements, components, and/or circuits serving analogous functions to what has been discussed in connection with the embodiment of FIGS. 1 to 6 will be indicated with analogous reference symbols to those used in the discussions on the embodiment of FIGS. 1 to 6 and will not be discussed in detail for simplicity where appropriate.

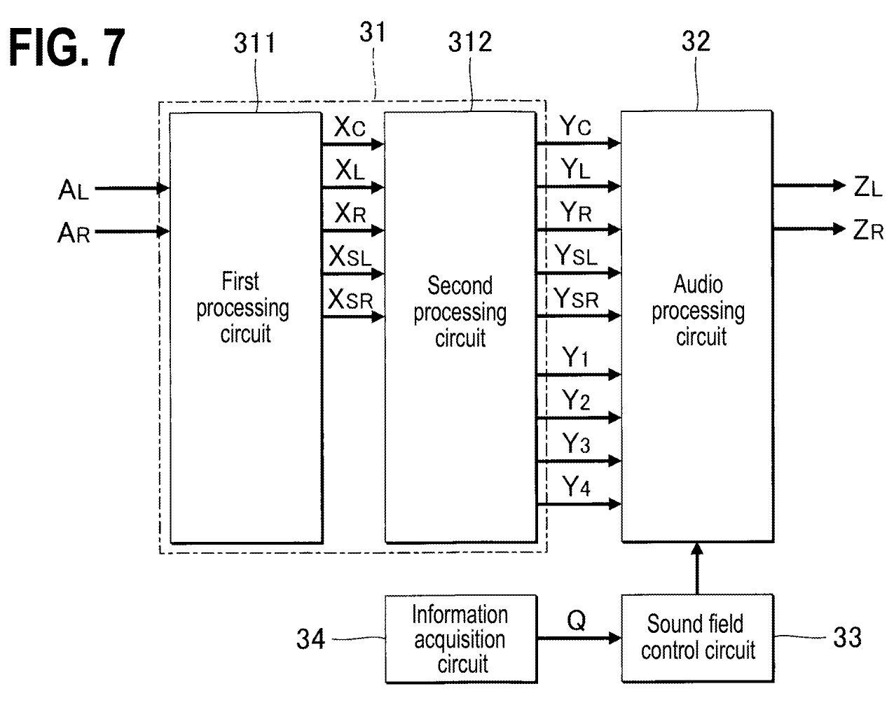

FIG. 7 is a block diagram illustrating example functional circuits of an audio output device 10 in accordance with another embodiment. In the instant embodiment, the control component 11 not only provides the same circuits (or the signal acquisition circuit 31, the audio processing circuit 32, and the sound field control circuit 33) as the embodiment of FIG. 3, but also implements the function of an information acquisition circuit 34. The signal acquisition circuit 31 and the audio processing circuit 32 have the same features and operations as the embodiment of FIG. 3.

The information acquisition circuit 34 acquires display information Q. The display information Q indicates the display size for displaying video for the piece of moving image content. In the instant embodiment, the information acquisition circuit 34 acquires the display information Q from the display apparatus 20. By way of example, the information acquisition circuit 34 acquires the display information Q during the course of the communication component 13 of the audio output device 10 establishing communication with the display apparatus 20. In the instant embodiment, the sound field control circuit 33 performs sound field control as a function of the display information Q. More specifically, as will be clear from the examples below, the localization angle α and the localization angle β are set as a function of the display information Q.

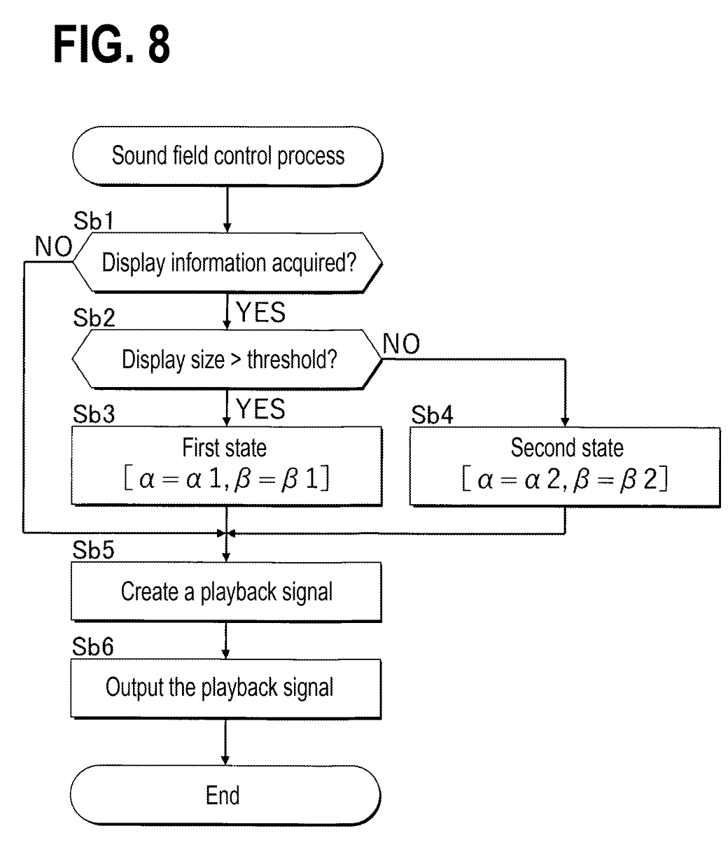

FIG. 8 is a flowchart of a sound field control process in accordance with the instant embodiment. Once the sound field control process begins, the control component 11 (or the information acquisition circuit 34) checks if the display information Q has been acquired (at step Sb1). If the display information Q has been acquired (YES at step Sb1), the control component 11 (or the sound field control circuit 33) checks if the display size indicated by the display information Q is above a predetermined threshold (at step Sb2). For example, the display size threshold is 16 inches.

If the display size indicated by the display information Q is a first size, which is above the threshold (YES at step Sb2), the control component 11 (or the sound field control circuit 33) tells the audio processing circuit 32 to enforce the first state exemplarily depicted in FIG. 4 (at step Sb3). That is, the control component 11 sets the localization angle α between the virtual speaker 40L and the virtual speaker 40R to the angle α1 and sets the localization angle β between the virtual speaker 40SL and the virtual speaker 40SR to the angle β1.

Meanwhile, if the display size indicated by the display information Q is a second size, which is below the threshold (NO at step Sb2), the control component 11 (or the sound field control circuit 33) tells the audio processing circuit 32 to enforce the second state exemplarily depicted in FIG. 5 (at step Sb4). That is, the control component 11 sets the localization angle α between the virtual speaker 40L and the virtual speaker 40R to the angle α2 and sets the localization angle β between the virtual speaker 40SL and the virtual speaker 40SR to the angle β2. The second size is smaller than the first size. As is clear from the foregoing, the control component 11 (or the sound field control circuit 33) in the instant embodiment sets the localization angle α and the localization angle β as a function of the display information Q.

The control component 11 (or the sound processing circuit 32) performs the localization process with the localization angle α and the localization angle β being set in the above fashion, to create the playback signal Z (or playback signal components ZL and ZR) (at step Sb5). And the control component 11 (or the audio processing circuit 32) feeds the playback signal Z (or playback signal components ZL and ZR) to the sound emission component 15 (at Step Sb6). More specifically, the playback signal component ZL is fed to the playback unit 15L, and the playback signal component ZR is fed to the playback unit 15R.

In contrast, if the display information Q is not acquired (NO at step Sb1), the control component 11 does not change the localization angle α or the localization angle β (at steps Sb3 and Sb4). That is, the sound field of the sound being played back according to the playback signal Z is kept in whichever of the first and second states is the initially set state or kept in the state brought about by the most recent change.

As a result of the implementation of the example sound field control process depicted above, the sound field of the sound being played back according to the playback signal Z is set to the first state in the case of the display size for the video in the piece of moving image content being the first size. Meanwhile, the sound field of the sound being played back according to the playback signal Z is set to the second state in the case of the display size for the video in the piece of moving image content being the second size. That is, just like the embodiment of FIGS. 1 to 6, the localization angle α in the case of the video being displayed on the display element 21 (when equal to the angle α1) is greater than the localization angle α in the case of the video being displayed on the display element 22 (when equal to the angle α2). Further, the localization angle β in the case of the video being displayed on the display element 21 (when equal to the angle β1) is greater than the localization angle β in the case of the video being displayed on the display element 22 (when equal to the angle β2).

The instant embodiment can produce the same effects and advantages as the embodiment of FIGS. 1 to 6. In addition, in the instant embodiment, the localization angle α and the localization angle β are set as a function of the display information Q indicating the display size for the video in the piece of moving image content. For this reason, in comparison to when the localization angle α and the localization angle β do not depend on the display size, a sound field that is optimized according to the display size for the video being watched by the user U can be established. In particular, in the instant embodiment, the larger the display size indicated by the display information Q is, the greater angles the localization angle α and the localization angle β are set to. Therefore, a sound field with optimized presence for the display size can be established around the user U.

By way of example, if the sound field for the sound being played back was fixed to the first state regardless of the display size, the user U, while watching video on the display element 22 with the smaller display size, might perceive that there is a discrepancy between the visual extension of the video and the acoustic expansion of the sound field. Similarly, if the sound field for the sound being played back was fixed to the second state regardless of the display size, the user U, while watching video on the display element 21 with the greater display size, might perceive that there is a discrepancy between the visual extension of the video and the acoustic expansion of the sound field. In the instant embodiment, the sound field is set to the first state when the display size is the first size, and the sound field is set to the second state when the display size is the second size. Therefore, the user U can enjoy a comfortable listening and watching experience thanks to the optimized alignment with harmony between the visual extension of the video and the acoustic expansion of the sound field.

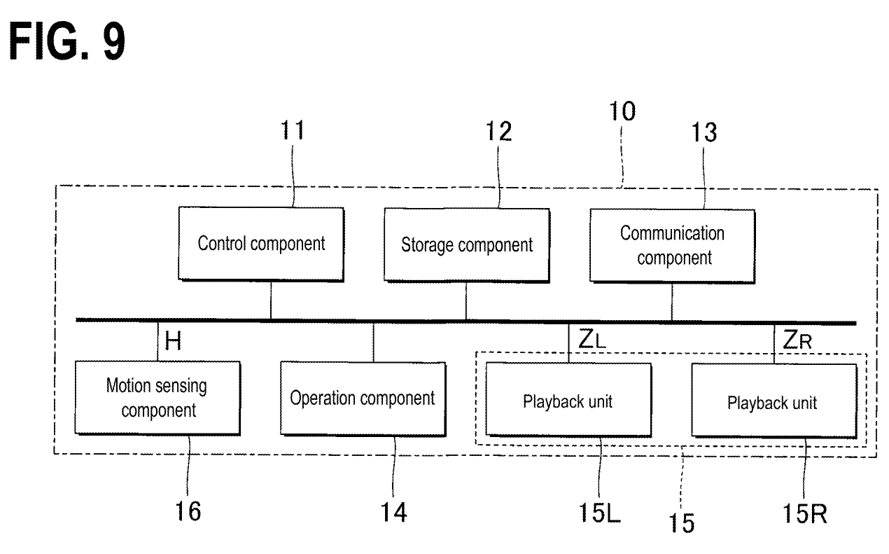

FIG. 9 is a block diagram illustrating an example configuration of an audio output device 10 in accordance with yet another embodiment. In the instant embodiment, the audio output device 10 includes the same components as the embodiment of FIG. 2 (or the control component 11, the storage component 12, the communication component 13, the operation component 14, and the sound emission component 15), and additionally includes a motion sensing component 16.

The motion sensing component 16 provides a sensor configured to sense the orientation of the head of the user U. More specifically, the motion sensing component 16 generates a sensing signal H indicating the orientation of the head of the user U. For instance, the motion sensing component 16 is constituted by at least one sensor type from among an acceleration sensor, a gyro sensor, and a geomagnetic sensor.

The signal acquisition circuit 31 and the sound field control circuit 33 in the instant embodiment have the same features and operations as the embodiment of FIG. 3. The audio processing circuit 32 in the instant embodiment may not only perform the same localization process as the embodiment of FIG. 3, but also carry out head tracking process. The head tracking process involves adjusting the positions of the virtual speakers 40 as a function of the orientation of the head of the user U sensed by the motion sensing component 16. More specifically, the audio processing circuit 32 shifts the positions of the virtual speakers 40 in the direction opposite to a change in the orientation of the head of the user U, such that the positions of the virtual speakers 40 in the space are fixed regardless of the orientation of the head of the user U.

The instant embodiment can produce the same effects and advantages as the embodiment of FIGS. 1 to 6. In addition, the instant embodiment can put the virtual speakers 40 fixed in position in the space where the user U is present, as the head tracking process is carried out in a way that accounts for the orientation of the head of the user U. It should be noted that the use of the display information Q in the control of the localization process in the immediately preceding embodiment may also be adopted in the instant embodiment.

An audio output device 10 in accordance with yet another embodiment will be described and has the same functional circuits as the embodiment exemplarily depicted in FIG. 7. That is, the control component 11 in the instant embodiment implements the functions of the same circuits as the embodiment of FIG. 7 (or the signal acquisition circuit 31, the audio processing circuit 32, the sound field control circuit 33, and the information acquisition circuit 34). The signal acquisition circuit 31, the audio processing circuit 32, and the sound field control circuit 33 have the same features and operations as the embodiment of FIG. 3. Further, the audio output device 10 in the instant embodiment includes a motion sensing component 16 as in the embodiment of FIG. 9.

The information acquisition circuit 34 in the instant embodiment generates display information Q to be used by the sound field control circuit 33 in sound field control. More specifically, the information acquisition circuit 34 generates the display information Q as a function of the orientation of the head of the user U sensed by the motion sensing component 16.

When the video for the piece of moving image content is displayed in a large display size, the user U makes a wide range of head movement for the orientation of his or her head. Meanwhile, when the video for the piece of moving image content is displayed in a small display size, the change required in the orientation of the head becomes small in comparison to when a large display size is employed. That is, a display size for video tends to correlate with the degree of change in the orientation of a head. In consideration of this tendency, the information acquisition circuit 34 in the instant embodiment estimates the display size as a function of the result of the motion sensing component 16 sensing the motion (or, for example, rotation) of the head of the user U, to generate the display information Q indicating the display size. For instance, the larger display size is indicated by the display information Q, the greater the motion of the head sensed by the motion sensing component 16 is.

As in the embodiment of FIGS. 7 and 8, the sound field control circuit 33 controls the sound field (or the localization angle α and the localization angle β) as a function of the display information Q. Thus, the instant embodiment can produce the same effects and advantages as the embodiment of FIGS. 7 and 8. In addition, in the instant embodiment, the display size is estimated as a function of the result of sensing the rotational motion of the head of the user U. Therefore, there is no need to provide for steps to acquire the display size from the display apparatus 20 or receive a specification of the display size from the user U.

The audio processing circuit 32 in the instant embodiment carries out the head tracking process exemplarily depicted in the embodiment of FIG. 9. As previously described, the head tracking process adjusts the positions of the virtual speakers 40 as a function of the orientation of the head of the user U sensed by the motion sensing component 16. That is, in the instant embodiment, the result of sensing by the motion sensing component 16 (or the sensing signal H) is used in the head tracking process in the audio processing circuit 32 as well as in the generation of the display information Q by the information acquisition circuit 34. For this reason, the configuration and processes of the audio output device 10 can be simplified in comparison to when different information is used for each of the head tracking process and the generation of the display information Q. Note, however, that the head tracking process may be omitted in the instant embodiment. In other words, the result of sensing by the motion sensing component 16 (or the sensing signal H) may be exclusively used in the generation of the display information Q by the information acquisition circuit 34.

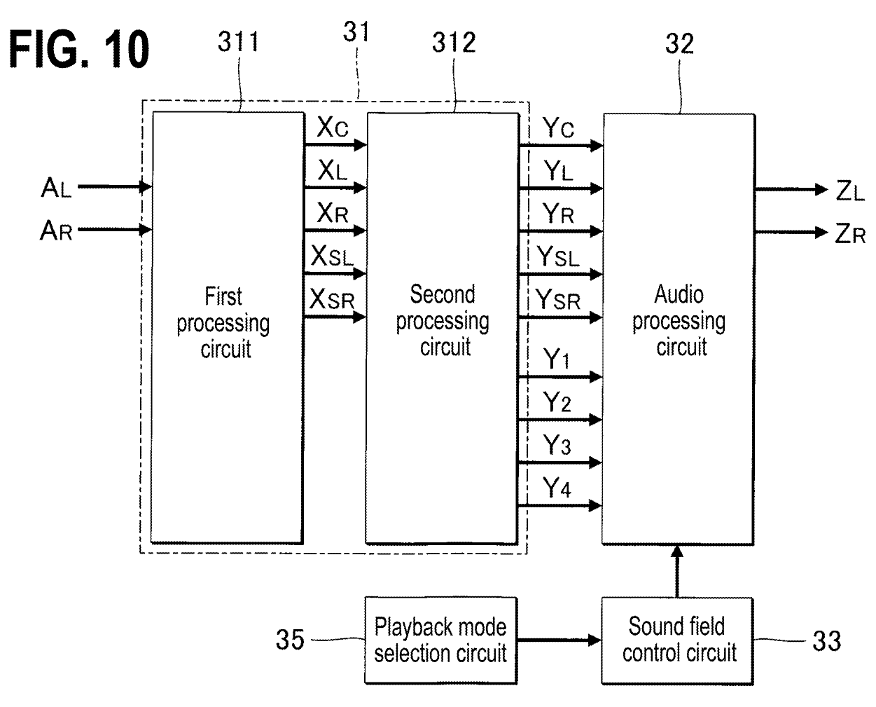

FIG. 10 is a block diagram illustrating example functional circuits of an audio output device 10 in accordance with yet another embodiment. In the instant embodiment, the control component 11 not only provides the same circuits (or the signal acquisition circuit 31, the audio processing circuit 32, and the sound field control circuit 33) as the embodiment of FIG. 3, but also implements the function of a playback mode selection circuit 35. The signal acquisition circuit 31 and the audio processing circuit 32 have the same features and operations as the embodiment of FIG. 3.

The playback mode selection circuit 35 selects one of a plurality of playback modes. A playback mode denotes a mode of operation to play back the sound in the piece of moving image content. More specifically, the playback mode selection circuit 35 selects one of a first playback mode or a second playback mode.

The first playback mode represents a mode of operation in which the spatial expansion of the sound field is prioritized. Examples of the first playback mode include a cinema mode, which is suitable for movies and other such moving image content where the sense of presence in grand scenes should be highlighted, and a live mode (or a concert hall mode) in which the sense of presence in an acoustically designed environment such as a music live venue and an auditorium should be highlighted.

The second playback mode represents a mode of operation in which a sound image localized in a front direction from the user U is prioritized. Examples of the second playback mode include a drama mode, which is suitable for dramas and other such moving image content where the lines from a character positioned at the center of images should be highlighted, and a musical performance mode, which is suitable for moving image content in which singing by a singer should be highlighted as part of musical performance by the singer positioned at the center within images and instrument players positioned around the singer.

The user U can operate the operation component 14 to specify one of the first playback mode or second playback mode. The playback mode selection circuit 35 selects one of the playback modes according to this operation by the user U on the operation component 14. In the embodiment of FIG. 10, the sound field control circuit 33 controls the sound field as a function of the result of selecting one of the playback modes by the playback mode selection circuit 35. More specifically, as will be clear from the examples below, the localization angle α and the localization angle β are set as a function of a playback mode.

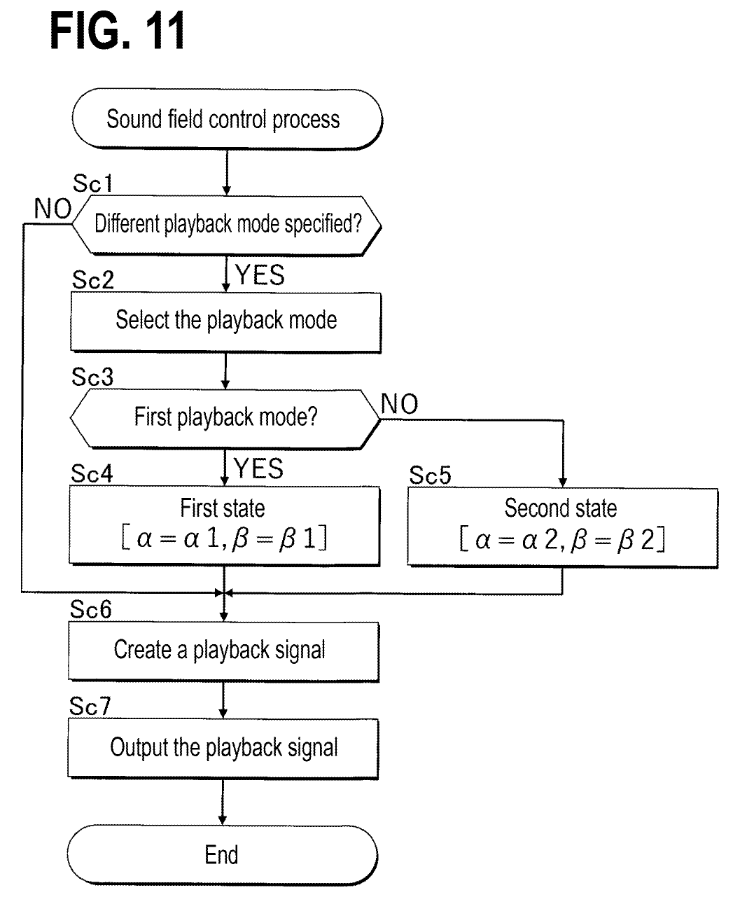

FIG. 11 is a flowchart of a sound field control process in accordance with the embodiment of FIG. 10. Once the sound field control process begins, the control component 11 (or the playback mode selection circuit 35) checks if a different playback mode has been specified by the user U (at step Sc1). If a different playback mode has been specified (YES at step Sc1), the control component 11 (or the playback mode selection circuit 35) selects the playback mode specified by the user U (at step Sc2). The control component 11 (or the sound field control circuit 33) checks if the currently selected playback mode is the first playback mode (at step Sc3).

If the currently selected playback mode is the first playback mode (YES at step Sc3), the control component 11 (or the sound field control circuit 33) tells the audio processing circuit 32 to enforce the first state exemplarily depicted in FIG. 4 (at step Sc4). That is, the control component 11 sets the localization angle α between the virtual speaker 40L and the virtual speaker 40R to the angle α1 and sets the localization angle β between the virtual speaker 40SL and the virtual speaker 40SR to the angle β1.

Meanwhile, if the currently selected playback mode is the second playback mode (NO at step Sc3), the control component 11 (or the sound field control circuit 33) tells the audio processing circuit 32 to enforce the second state exemplarily depicted in FIG. 5 (at step Sc5). That is, the control component 11 sets the localization angle α between the virtual speaker 40L and the virtual speaker 40R to the angle α2 and sets the localization angle β between the virtual speaker 40SL and the virtual speaker 40SR to the angle β2.

The control component 11 (or the sound control circuit 32) performs the localization process with the localization angle α and the localization angle β being set in the above fashion, to create the playback signal Z (or playback signal components ZL and ZR) (at step Sc6). Also the control component 11 (or the audio processing circuit 32) feeds the playback signal Z (or playback signal components ZL and ZR) to the sound emission component 15 (at step Sc7). More specifically, the playback signal component ZL is fed to the playback unit 15L, and the playback signal component ZR is fed to the playback unit 15R.

In contrast, if a different playback mode is not specified (NO at step Sc1), the control component 11 does not change the localization angle α or the localization angle β (at steps Sc4 and Sc5). That is, the sound field of the sound being played back according to the playback signal Z is kept in a state associated with an initially selected one of the playback modes or kept in a state associated with the playback mode selected by the most recent change.

As a result of the implementation of the example sound field control process depicted above, the sound field of the sound being played back according to the playback signal Z is set to the first state in the case of the playback mode being the first playback mode. Meanwhile, the sound field of the sound being played back according to the playback signal Z is set to the second state in the case of the playback mode being the second playback mode. That is, the localization angle α during the first playback mode (when equal to the angle α1) is greater than the localization angle α during the second playback mode (when equal to the angle α2). Further, the localization angle β during the first playback mode (when equal to the angle β1) is greater than the localization angle β during the second playback mode (when equal to the angle β2).

The instant embodiment can produce the same effects and advantages as the embodiment of FIGS. 1 to 6. In addition, in the instant embodiment, the localization angle α and the localization angle β are set according to a playback mode. For this reason, in comparison to when the localization angle α and the localization angle β are fixed, a sound field that matches a playback mode can be established.

While, in the embodiment of FIGS. 10 and 11, the localization angle α and the localization angle β are controlled according to a playback mode, the sound field control circuit 33 may control not only the localization angle α and the localization angle β but also the reverberation characteristics of the sound represented by the playback signal Z (or playback signal components ZL and ZR) being played back, according to a playback mode, in accordance with yet another embodiment. It should be recognized that the localization angle α and the localization angle β are controlled according to a playback mode in the same manner as in the embodiment of FIGS. 10 and 11.

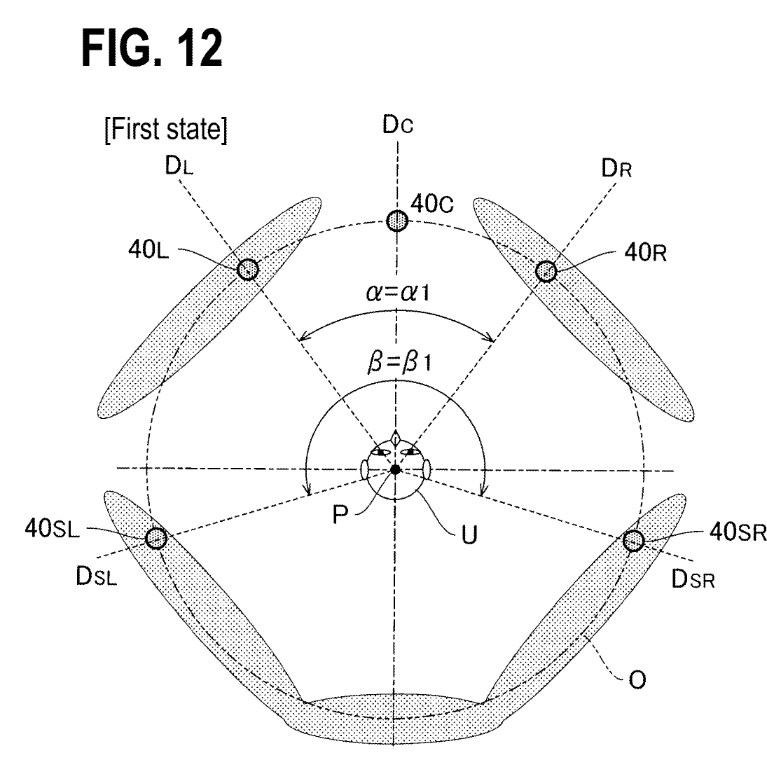

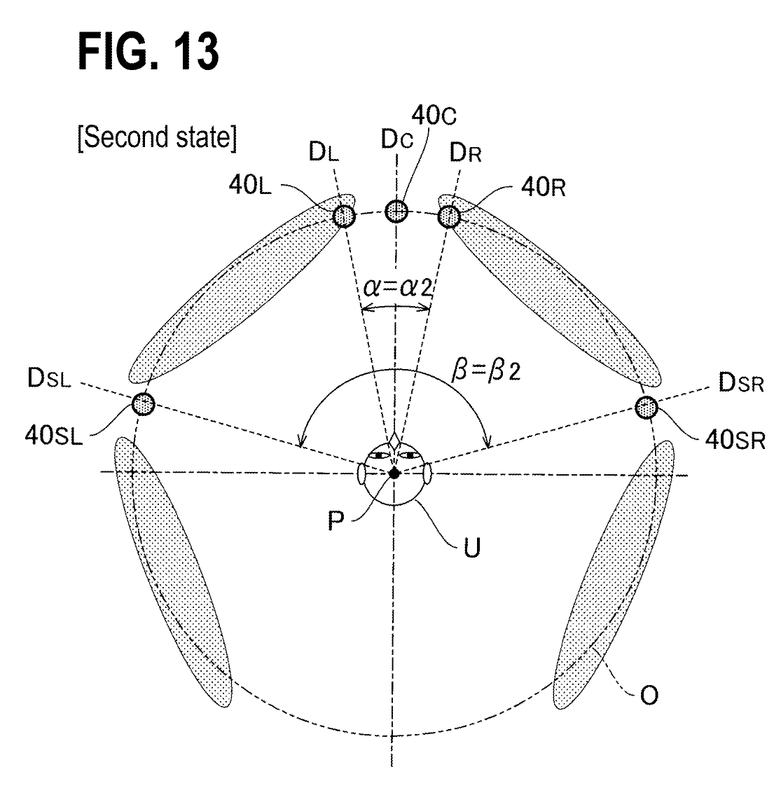

FIG. 12 schematically shows the first state of the sound field of the sound being played back and corresponds to FIG. 4, already shown previously. FIG. 13 schematically shows the second state of the sound field of the sound being played back and corresponds to FIG. 5, already shown previously. In FIGS. 12 and 13, the spatial expansion of the reverberation sound for the sound represented by the playback signal Z (or playback signal components ZL and ZR) being played back is shown in a halftone pattern.

As exemplarily illustrated in FIGS. 12 and 13, the spatial expansion of the reverberation sound in the first state is greater than the spatial expansion of the reverberation sound in the second state. The signal acquisition circuit 31 (or the second processing circuit 312) creates the audio signal components Y1 to Y4 to represent the reverberation sound. That is, the signal acquisition circuit 31 subjects the audio signal X (or audio signal components XC, XL, XR, XSL, and XSR) to a reverberation process designed to create the audio signal components Y1 to Y4 for the reverberation sound. The signal acquisition circuit 31 can adjust reverberation parameters applied to the reverberation process to control the spatial expansion of the reverberation sound. Examples of the reverberation parameters include the volume of reverberation sound, the duration of reverberation, a delay time due to early reflections, and a reverberation density (or the number of reflections from sound emission to reception).

The localization angle α and the localization angle β are controlled according to a playback mode in the same manner as in the embodiment of FIGS. 10 and 11. That is, the sound field for the sound being played back is controlled to the first state during the first playback mode, and the sound field for the sound being played back is controlled to the second state during the second playback mode. Referring to FIG. 12, in the first state, the localization angle α is set to the angle α1 and the localization angle β is set to the angle β1, and the reverberation parameters of the reverberation process are set to achieve a greater spatial expansion of the reverberation sound. Meanwhile, in the second state, the localization angle α is set to the angle α2 and the localization angle β is set to the angle β2, and the reverberation parameters of the reverberation process are set to achieve a smaller spatial expansion of the reverberation sound. As is clear from the foregoing, in the instant embodiment, the reverberation characteristics of the sound being played back are controlled in dependence on the localization angles α and β.

The instant embodiment can produce the same effects and advantages as the embodiment of FIGS. 10 and 11. In addition, in the instant embodiment, the reverberation characteristics are controlled in dependence on the localization angles α and β. For this reason, in comparison to the embodiment of FIGS. 10 and 11, the spatial expansion of the sound field can be controlled in a more variable and advantageous manner. It should be noted that control of the reverberation characteristics in dependence on the localization angles α and β, as performed in accordance with the instant embodiment, may also be adopted in the previous embodiments.

The followings are variant configurations that can be incorporated into one of the embodiments exemplarily discussed above. Any two or more of the configurations selected from the followings may be combined with each other, as appropriate, to the extent that they do not become inoperable together.

In the example embodiment of FIGS. 1 to 6, the user U specifies which one of the display elements 21 and 22 is to be used as a player appliance for the piece of moving image content. However, this represents merely one of the non-limiting examples of what can be specified by the user U in the embodiment of FIGS. 1 to 6. For instance, in the embodiment of FIGS. 1 to 6, the control component 11 (or the sound field control circuit 33) may receive from the user U the value for the display size of the player appliance. In the sound field control process, the control component 11 checks if the display size specified by the user U is above a threshold (at, for example, 16 inches) (at step Sa2). The control component 11 (or the sound field control circuit 33) tells the audio processing circuit 32 to enforce the first state depicted in FIG. 4, if the display size is above the threshold (at step Sa3). The control component 11 (or the sound field control circuit 33) tells the audio processing circuit 32 to enforce the second state depicted in FIG. 5, if the display size is below the threshold (at step Sa4). This variant configuration can produce the same effects and advantages as the embodiment of FIGS. 1 to 6.

In the example embodiment of FIGS. 7 and 8, the display information Q is transmitted from the display apparatus 20 to the audio output device 10. However, this represents merely one of the non-limiting examples of how the display information Q is acquired by the information acquisition circuit 34, and may be modified as needed. For instance, the information acquisition circuit 34 may be configured to generate the display information Q as a function of the operation on the operation component 14 by the user U. By way of example, the information acquisition circuit 34 may be configured to generate the display information Q as a function of a specification from the user U to select one of the display element 21 or the display element 22, or may be configured to generate the display information Q as a function of a specification from the user U with respect to the display size of the player appliance.

In the example embodiment of FIGS. 10 and 11, the user U specifies a playback mode. However, this represents merely one of the non-limiting examples of how a playback mode is selected by the playback mode selection circuit 35, and may be modified as needed. For instance, the playback mode selection circuit 35 may select a playback mode as a result of estimating a scene from the piece of moving image content. A scene from the piece of moving image content signifies the type of a particular scene in the piece of moving image content. By way of example, the piece of moving image content is analyzed to estimate various scenes including a standard scene, a conversation scene, a musical performance scene, an action scene, and a music live scene. Any known analysis technique may be employed to analyze a scene in the piece of moving image content. An appropriate playback mode is registered in advance for each of different scenes such that the playback mode selection circuit 35 can select a playback mode to be assigned to a scene estimated from the piece of moving image content. This variant configuration is advantageous in that the user U does not have to specify a playback mode.

In the previously described embodiments, the first state and the second state are used as the illustrative example of possible states of the sound field for the sound being played back. However, the sound field for the sound being played back may even be set to one of more than two states. The localization angle α and the localization angle β may be set differently for each of the states of the sound field.

In the previously described embodiments, the audio processing functions (or the signal acquisition circuit 31, the audio processing circuit 32, the sound field control circuit 33, the information acquisition circuit 34, and/or the playback mode selection circuit 35) for creating the playback signal Z (or playback signal components ZL and ZR) are implemented by the audio output device 10. However, a part or entirety of the audio processing functions may be implemented in the display apparatus 20 (or display elements 21 and 22). That is, the display apparatus 20 may use the audio processing functions to create the playback signal Z (or playback signal components ZL and ZR) from the audio signal A (or audio signal components AL and AR) and transmit the playback signal Z (or playback signal components ZL and ZR) to the audio output device 10, which, in turn, plays back the same.

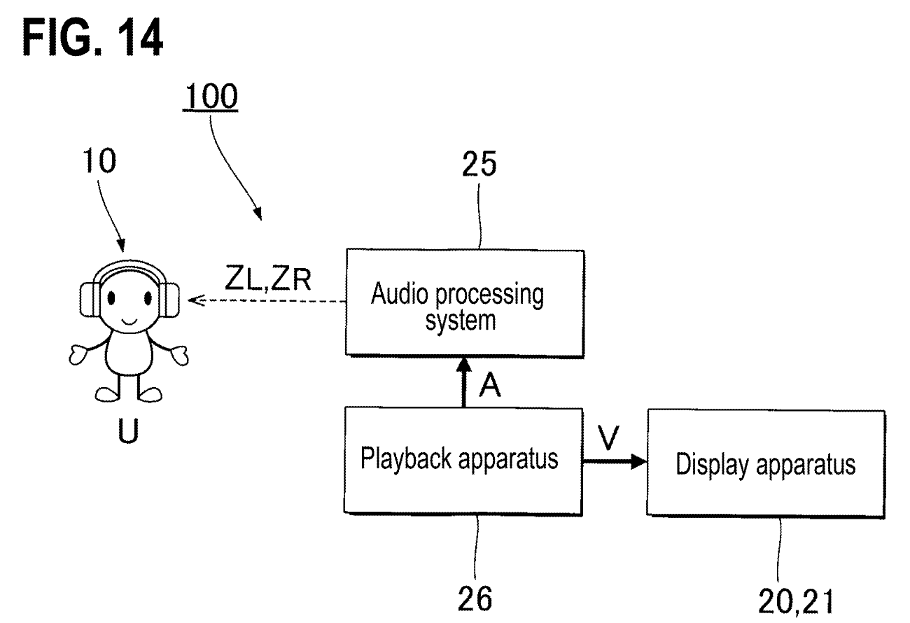

Additionally or alternatively, as illustrated in FIG. 14, the audio processing functions may be implemented in an audio process system 25, which is separate from the audio output device 10. By way of example, the audio process system 25 is in the form of an audio/visual (AV) receiver that includes, among others, an amplifier for amplifying the audio signal A (or audio signal components AL and AR). The audio output device 10 may be linked to the audio process system 25 through cabled or wireless communication.

The display apparatus 20 and the audio process system 25 may be linked to a playback apparatus 26 through cabled or wireless communication. By way of example, the playback apparatus 26 represents an AV appliance for playing back a piece of moving image content recorded in a digital versatile disc (DVD), a Blu-ray (registered trademark) disc, or other such optical disk. More specifically, the playback apparatus 26 provides the video signal V for the piece of moving image content to the display apparatus 20, while, in parallel, providing the audio signal A (or audio signal components AL and AR) for the piece of moving image content to the audio process system 25.

The display apparatus 20 displays video represented by the video signal V provided from the playback apparatus 26. The audio process system 25 subjects the audio signal A provided from the playback apparatus 26 to the audio processing functions to create the playback signal Z (or playback signal components ZL and ZR) and transmits the playback signal Z to the audio output device 10. The audio output device 10 plays back sound represented by the playback signal Z.

It should be recognized that the audio process system 25 may additionally or alternatively transmit the audio signal A to the audio output device 10, which, in turn, uses the audio processing functions to create and play back the playback signal Z (or playback signal components ZL and ZR). That is, the audio processing functions may alternatively or additionally be provided somewhere other than the audio process system 25.

In some examples, a terminal device, such as a smartphone, a tablet computer, or a personal computer, that is linked to the audio output device 10 may be used as the audio process system 25. The audio process system 25 may use the audio processing functions to create the playback signal Z (or playback signal components ZL and ZR) and feed the same to the audio output device 10, which, in turn, plays back the same.

In the previously described embodiments, the size of a screen of the display apparatus 20 is defined as the display size of the display apparatus 20. However, the size of a screen of the display apparatus 20 merely represents one of the non-limiting examples of the display size of the display apparatus 20. For instance, the size of an area on which the video for the piece of moving image content is displayed – for example, a view window – within the screen of the display apparatus 20 may even be interpreted as the display size of the display apparatus 20.

In the previously described embodiments, the signal acquisition circuit 31 creates the audio signal Y. However, the signal acquisition circuit 31 may additionally or alternatively receive an externally created audio signal Y (or audio signal components YC, YL, YR, YSL, YSR, and Y1 to Y4). That is, the first processing circuit 311 and the second processing circuit 312 may be omitted in the previously described embodiments. As is clear from the foregoing, the “acquisition” of the audio signal Y by the signal acquisition circuit 31 covers both an embodiment in which the audio signal Y is created by the signal acquisition circuit 31 and an embodiment in which the audio signal Y is created by and received from an external entity.

In the example embodiment of FIGS. 7 and 8, the localization angle α and the localization angle β are controlled to one of two values according to whether the display size is above the threshold or not. However, the localization angle α and the localization angle β may alternatively be each set to one of three or more discrete values. By way of example, a plurality of ranges (or, for example, three or more ranges) of values, into one of which the display size falls, can be associated with different combinations of angle values for the localization angle α and the localization angle β. The control component 11 (or the sound field control circuit 33) may check which one of the plurality of ranges of values the display size represented by the display information Q falls within, in order to set the localization angle α and the localization angle β to angle values associated with the corresponding one of the ranges.

According to the present disclosure, as can be seen from the foregoing, the “first angle” denotes a given angle selected from among a plurality of angles (or a selected number of angles), and the “second angle” denotes a given angle selected from among the plurality of angles but different from the first angle. A different number of angles, from which to select the first and second angles, may be used as needed.

In the previously described embodiments, the localization angle β between the virtual speaker 40SL and the virtual speaker 40SR changes in dependence on the localization angle α between the virtual speaker 40L and the virtual speaker 40R. However, the localization angle β may alternatively be kept at a fixed angle. That is, control of the localization angle β may be omitted.

In the previously described embodiments, the angle of the virtual speaker 40L (or the direction DL) relative to the direction DC of the exact front side of the listening point P is identical to the angle of the virtual speaker 40R (or the direction DR) relative to the direction DC of the exact front side of the listening point P. That is, in the previously described embodiments, the direction DC of the exact front side of the listening point P represents a bisector of the localization angle α. However, the angle of the virtual speaker 40L (or the direction DL) relative to the direction DC of the exact front side may alternatively be different from the angle of the virtual speaker 40R (or the direction DR) relative to the direction DC of the exact front side. This also applies to the relationship between the virtual speaker 40SL and the virtual speaker 40SR; the angle of the virtual speaker 40SL (or the direction DSL) relative to the direction DC of the exact front side of the listening point P may be different from the angle of the virtual speaker 40SR (or the direction DSR) relative to the direction DC of the exact front side of the listening point P.

In an example embodiment, the audio processing functions (or the signal acquisition circuit 31, the audio processing circuit 32, the sound field control circuit 33, the information acquisition circuit 34, and/or the playback mode selection circuit 35) may be implemented by an audio process server in communication with a terminal device such as a smartphone and a tablet computer. The audio process server may use the aforementioned sound field control process to create the playback signal Z (or playback signal components ZL and ZR) and transmit the same to the terminal device over a telecommunication network. A sound emission component implemented in or connected to the terminal device may play back the playback signal Z.

As is clear from the previously described embodiments, a part or entirety of the audio processing functions (or the signal acquisition circuit 31, the audio processing circuit 32, the sound field control circuit 33, the information acquisition circuit 34, and/or the playback mode selection circuit 35) is provided by the cooperation between a single processor or several processors implementing the control component 11 and the program stored in the storage component 12. A program according to the present disclosure may be stored in a computer-readable recording medium and installed to a computer. In an example embodiment, the recording medium is a non-transitory recording medium. An optical recording medium (or an optical disk) such as a CD-ROM is a suitable example of the non-transitory recording medium. Nevertheless, a semiconductor recording medium, a magnetic recording medium, and any other known forms of a recording medium can also be encompassed by the non-transitory recording medium. It should be noted that the non-transitory recording medium encompasses any forms of a recording medium that are not characterized by transitory propagating signals, and can even encompass volatile recording media. Aso, where the program is distributed from a source entity over a telecommunication network, a storage medium on which the program is stored at the source entity corresponds to the non-transitory recording medium discussed above.

The ordinal numbers “first, second, …, and n-th” where n is a natural number are only used herein as systematic and convenient labels to distinguish different units of the same element and do not have any substantial implications whatsoever. Therefore, the use of an ordinal number like “first, second, …, and n-th” cannot constitute a reason to interpret in a limiting way the positions of different units of the same element, the order of steps in a manufacturing process, and so on.

By way of example, the previously described embodiments and configurations can give rise to the following implementations.

A computer system-implemented audio processing method according to one implementation of the present disclosure includes acquiring two or more audio signals. The method also includes subjecting the two or more audio signals to a localization process to create two or more playback signals. The localization process includes localizing sound images from a plurality of virtual speakers including a first virtual speaker located in a front left direction from a listening point for a listener and a second virtual speaker located in a front right direction from the listening point. The localizing the sound images includes setting a localization angle formed about the listening point between the first virtual speaker and the second virtual speaker to one of different angles in the localization process. In the instant implementation, the localization angle formed about the listening point between the first virtual speaker and the second virtual speaker is set to one of different angles. For this reason, in comparison to when the localization angle is fixed, a sound field that is optimal for a listener can be established.

The term “listening point” used herein refers to a representative point in or on a listener to the sound as represented by the two or more playback signals being played back. For instance, a central point of the head of the listener serves as one of the illustrative examples of the “listening point”. The “front left direction” from the listening point refers to a given direction within the range delimited between an exact front direction from the listening point and a lateral left direction from the listening point. The “front right direction” from the listening point refers to a given direction within the range delimited between the exact front direction from the listening point and a lateral right direction from the listening point.

The term “virtual speaker” used herein refers to an imaginary speaker that is perceived by a listener as if it were playing back and emitting sound represented by the two or more playback signals. The localization process relies on a head-related impulse response function to control the positions (or localization) of the sound images from the virtual speakers as perceived by a listener. By listening to the sound being played back by and emitted from the virtual speakers, a listener can perceive the localization of virtual sound sources that will hereinafter be each referred to as an “imaginary sound source”. As is clear from the foregoing, the virtual speakers are imaginary speakers positioned around a listener so as to correspond to different playback channels (or, for example, five channels). Meanwhile, the virtual sound sources refer to sound images (or objects) that are perceptible by a listener as he or she listens to the sound being played back by and emitted from the virtual speakers corresponding to the different playback channels.

The feature of the localization angle being “set to one of different angles” means that the localization angle can be set to either the first angle or the second angle, which is different from the first angle. For instance, the localization process sets the localization angle by switching the localization angle from the first angle to the second angle and vice versa, among the different angles.

In a particular form of the previous implementation, the audio processing method further includes receiving a specification from a user. The setting the localization angle includes setting the localization angle according to the specification from the user. In the instant implementation, the localization angle is set according to the specification from the user. Therefore, a sound field that matches the preference of an individual user can be established.

The term “user” used herein typically refers to a listener to the sound represented by the playback signal being played back, but can also refer to a non-listener. The phrase “specification from a user” used herein refers to any specification used to control the settings for the localization angle. Examples of the “specification from a user” to be received include a specification to directly specify the localization angle, a specification to specify an element (or, for example, the display size) on which the localization angle depends, and a specification to select one of a plurality of playback modes with different localization angles. It should be noted that any method can be used to receive the “specification from a user”. Examples of the method include receiving a specification from a user acting on an operation component and receiving a specification (or voice input) from a user speaking on a sound collector component.

In a particular form of one of the previous implementations, the audio processing method further includes acquiring display information indicating a display size for displaying video to be paired with the two or more audio signals. Setting the localization angle includes setting the localization angle as a function of the display information. In the instant implementation, the localization angle is set as a function of the display information indicating the display size for the video to be paired with the two or more audio signals. For this reason, in comparison to when the localization angle does not depend on the display size, a sound field that is optimized according to the display size for the video being watched by a listener can be established.

The phrase “video to be paired with two or more audio signals” used herein refers to video made with the intention of being displayed in a paired manner with the two or more audio signals. For instance, a typical example of the “video to be paired with two or more playback signals” is video that is displayed in combination with the sound represented by the two or more audio signals being played back. More specifically, one of illustrative examples of “video to be paired with two or more audio signals” is video that, together with the two or more audios signals, makes up a complete piece of moving image content.

The term “display information” used herein refers to any piece of information indicating a display size. By way of example, the term “display information” can encompass a value directly expressing the display size, as well as any piece of information that can serve as an indicator of the display size. According to the present disclosure, any method can be used to generate the “display information”. For instance, display size information that can be acquired from the display apparatus serves as one of the illustrative examples of the “display information”. Also, information indicative of the display size specified by a user such as, for example, a listener, through an input component serves as another one of the illustrative examples of the “display information”. Further, display size information estimated from, for example, a motion of a listener like a change in gaze or rotation of the head can also be encompassed by the term “display information”.

The feature of “setting the localization angle as a function of the display information” means changing the localization angle in dependence on a change in the display information. For instance, when it is assumed that the display information indicates either one of mutually different first and second information, the feature of setting the localization angle to the first angle when the display information indicates the first information and setting the localization angle to the second angle different from the first angle when the display information indicates the second information corresponds to “setting the localization angle as a function of the display information”. It is not necessary for the localization angle to be changed whenever there is a change in the display information (or, for example, the display size). For instance, the localization angle may be kept at a constant angle as long as the change occurring in the display information stays within a predetermined range.

In a particular form of the directly preceding implementation, the setting the localization angle includes setting the localization angle to a first angle when the display size indicated by the display information is a first size and setting the localization angle to a second angle smaller than the first angle when the display size indicated by the display information is a second size smaller than the first size. In the instant implementation, the larger the display size indicated by the display information is, the greater angles the localization angles are set to. Hence, a sound field with a spatial expansion optimized for the display size can be established around the listening point.

The localization angle for when the display size is between the first size and the second size does not matter, as long as the localization angle (or the second angle) in the case of the display size being the second size is smaller than the localization angle (or the first angle) in the case of the display size being the first size.

In a particular form of one of the immediately preceding two implementations, the acquiring the display information includes sensing a motion of the listener, and estimating the display size as a function of a result of sensing the motion to generate the display information indicating the display size. In the instant implementation, the display size is estimated as a function of a result of sensing the motion of the listener. For this reason, there is no need to provide for steps to acquire the display size from the display apparatus or receive a specification of the display size from the user.

By way of example, the “motion” of the listener is a motion that depends on the display size. For instance, given the tendency for the range of gaze of the listener to change according to the display size, the movement of the gaze of the listener serves as one of the illustrative examples of the “motion” of the interest being sensed. Also, in light of the tendency for the rotational angle of the head of the listener to change according to the display size, the rotation of the head of the listener serves as another one of the illustrative examples of the “motion” of the interest being sensed.

It should be recognized that any method can be used to estimate the display size as a function of a result of sensing the motion. By way of example, it can be envisioned to provide a prepared table in which different sensing results and different display sizes are associated and use this table to identify a display size to be associated with the actual sensing result. Additionally or alternatively, the sensing result may be applied to a predetermined set of computations to calculate the display size. Additionally or alternatively, machine learning may be used to train an estimation model using relationships between sensing results and display sizes, so that the estimation model can be used to generate a display size to be associated with the actual sensing result.

In a particular form of one of the previous implementations, the audio processing method further includes selecting one of a plurality of playback modes. The setting the localization angle includes setting the localization angle as a function of a result of the selecting one of the playback modes. In the instant implementation, the localization angle is selected according to a result of selecting one of the playback modes. For this reason, a sound field that matches a playback mode can be established.

The term “playback mode” refers to a mode of operation defining various settings related to the playback of a piece of content. Examples of a playback mode to be envisioned include a “standard mode” in which a piece of content is played back using a standard process and settings, a “drama mode” in which lines from a character should be emphasized, a “music mode” in which the mutual balance between many musical instruments with a singer at the center should be valued, a “cinema mode” in which the grandness of a scene for films and other such works of images should be valued, a “live mode” in which the sense of presence in a music live and other such events should be highlighted, and a “game mode” which is suitable for video game play. Any method can be used to select a “playback mode”. For instance, it can be envisioned to analyze a piece of content to estimate the type of the piece of content and select a playback mode according to the estimation result. Additionally or alternatively, a playback mode may be selected according to a specification from a user.

In a particular form of one of the previous implementations, the plurality of virtual speakers include a third virtual speaker located in a lateral left direction from the listening point and a fourth virtual speaker located in a lateral right direction from the listening point. The localizing sound images includes displacing the third virtual speaker and the fourth virtual speaker as a function of a change in the localization angle in the localization process. In the instant implementation, the positions of the third virtual speaker and the fourth virtual speaker are controlled in dependence on the localization angle between the first virtual speaker and the second virtual speaker. For this reason, the overall sound field containing the third virtual speaker and the fourth virtual speaker in addition to the first virtual speaker and the second virtual speaker can be controlled to achieve an optimal sound field for a listener.

The third virtual speaker and the fourth virtual speaker may be displaced in any fashion as a function of a change in the localization angle. For instance, in one example, the smaller the localization angle between the first virtual speaker and the second virtual speaker, the closer the third virtual speaker and the fourth virtual speaker are displaced towards the exact front direction from the listening point (or the center channel). The localization angle formed about the listening point between the third virtual speaker and the fourth virtual speaker depends on the localization angle between the first virtual speaker and the second virtual speaker. Note that it is not necessary for the positions of the third virtual speaker and the fourth virtual speaker to be changed whenever there is a change in the localization angle between the first virtual speaker and the second virtual speaker. For instance, the positions of the third virtual speaker and the fourth virtual speaker do not have to be modified, as long as the change occurring in the localization angle between the first virtual speaker and the second virtual speaker stays within a predetermined range.

A playback system according to another implementation of the present disclosure includes a circuitry configured to acquire two or more audio signals. The circuitry is also configured to perform audio processing. The audio processing includes subjecting the two or more audio signals to a localization process to create two or more playback signals. The localization process includes localizing a plurality of virtual speakers including a first virtual speaker located in a front left direction from a listening point for a listener and a second virtual speaker located in a front right direction from the listening point. The circuitry is also configured to perform sound field control. The sound field control includes setting a localization angle formed about the listening point between the first virtual speaker and the second virtual speaker to one of different angles in the localization process.

A playback system according to another implementation of the present disclosure causes a computer system to carry out a method that includes acquiring two or more audio signals. The method also includes performing audio processing. The audio processing includes subjecting the two or more audio signals to a localization process to create two or more playback signals. The localization process includes localizing a plurality of virtual speakers including a first virtual speaker located in a front left direction from a listening point for a listener and a second virtual speaker located in a front right direction from the listening point. The method also includes performing sound field control. The sound field control includes setting a localization angle formed about the listening point between the first virtual speaker and the second virtual speaker to one of different angles in the localization process.

It is worthwhile to note that a storage medium storing a program represented by software for realizing the present disclosure can be loaded into an information processing device or an associated memory to produce similar advantages according to the present disclosure. In that case, the program code read from the storage medium implements a set of novel functions of the present disclosure, and the non-transitory, computer-readable storage medium storing the program code forms one aspect of the present disclosure. In some examples, the program code may also be conveyed on a propagation medium. In that case, the program code itself forms another aspect of the present disclosure. It should be noted that examples of the storage medium that can be adopted in these situations include a ROM, a diskette, a hard disk, an optical disk, a magneto-optical disk, a CD-ROM, a CD-R, a magnetic tape, and a non-volatile memory card. Examples of the non-transitory, computer-readable storage medium can even encompass those entities that retain the program for some duration of time, such as volatile memories (e.g., a DRAM (or Dynamic Random Access Memory)) within a computer system that serves as a server and/or client used to transmit the program over a network such as the Internet and/or a communication line such as a telephone line.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A computer system-implemented audio processing method comprising:
acquiring two or more audio signals; and
performing a localization process on the two or more audio signals to create two or more playback signals,
wherein performing the localization process comprises localizing sound images from a plurality of virtual speakers including a first virtual speaker located in a front left direction from a listening point for a listener and a second virtual speaker located in a front right direction from the listening point, and
wherein the localizing the sound images includes setting a localization angle formed about the listening point between the first virtual speaker and the second virtual speaker to one of different angles in the localization process.

2. The audio processing method according to claim 1, further comprising:
receiving a specification from a user,
wherein the setting the localization angle includes setting the localization angle according to the specification from the user.

3. The audio processing method according to claim 1, further comprising:
acquiring display information indicating a display size for displaying video to be paired with the two or more audio signals,
wherein the setting the localization angle includes setting the localization angle as a function of the display information.

4. The audio processing method according to claim 3,
wherein the setting the localization angle includes setting the localization angle to a first angle in response to the display size indicated by the display information being a first size, and setting the localization angle to a second angle smaller than the first angle in response to the display size indicated by the display information being a second size smaller than the first size.

5. The audio processing method according to claim 4,
wherein the acquiring the display information includes sensing a motion of the listener, and estimating the display size as a function of a result of the sensing the motion to generate the display information indicating the display size.

6. The audio processing method according to claim 3,
wherein the acquiring the display information includes sensing a motion of the listener, and estimating the display size as a function of a result of the sensing the motion to generate the display information indicating the display size.

7. The audio processing method according to claim 1, further comprising:
selecting one of a plurality of playback modes,
wherein the setting the localization angle includes setting the localization angle as a function of a result of the selecting one of the playback modes.

8. The audio processing method according to claim 1,
wherein the plurality of virtual speakers include a third virtual speaker located in a lateral left direction from the listening point and a fourth virtual speaker located in a lateral right direction from the listening point, and
wherein the localizing sound images includes displacing the third virtual speaker and the fourth virtual speaker as a function of a change in the localization angle in the localization process.

9. A playback system comprising:
circuitry configured to:
acquire two or more audio signals;
perform audio processing comprising performing a localization process on the two or more audio signals to create two or more playback signals, wherein the localization process comprises localizing a plurality of virtual speakers including a first virtual speaker located in a front left direction from a listening point for a listener and a second virtual speaker located in a front right direction from the listening point; and
perform sound field control comprising setting a localization angle formed about the listening point between the first virtual speaker and the second virtual speaker to one of different angles in the localization process.

10. The playback system according to claim 9,
wherein the circuitry is configured to:
receive a specification from a user; and
set the localization angle according to the specification from the user.

11. The playback system according to claim 9,
wherein the circuitry is configured to:
acquire display information indicating a display size for displaying video to be paired with the two or more audio signals; and
set the localization angle as a function of the display information.

12. The playback system according to claim 11,
wherein the circuitry is configured to:
set the localization angle to a first angle in response to the display size indicated by the display information being a first size; and
set the localization angle to a second angle smaller than the first angle in response to the display size indicated by the display information being a second size smaller than the first size.

13. The playback system according to claim 12,
wherein the circuitry is configured to:
acquire the display information by sensing a motion of the listener, and estimating the display size as a function of a result of the sensing the motion to generate the display information indicating the display size.

14. The playback system according to claim 11,
wherein the circuitry is configured to:
acquire the display information by sensing a motion of the listener, and estimating the display size as a function of a result of the sensing the motion to generate the display information indicating the display size.

15. The playback system according to claim 9,
wherein the circuitry is configured to:
select one of a plurality of playback modes; and
set the localization angle as a function of a result of the selecting one of the playback modes.

16. The playback system according to claim 9,
wherein the plurality of virtual speakers include a third virtual speaker located in a lateral left direction from the listening point and a fourth virtual speaker located in a lateral right direction from the listening point, and
wherein the circuitry is configured to:
localize sound images by displacing the third virtual speaker and the fourth virtual speaker as a function of a change in the localization angle in the localization process.

17. A non-transitory computer-readable storage medium storing a program executable by at least one processor of a computer system, that when executed by the at least one processor, causes the at least one processor to carry out a method comprising:
acquiring two or more audio signals;
performing audio processing comprising performing a localization process on the two or more audio signals to create two or more playback signals, wherein perfoming the localization process comprises localizing a plurality of virtual speakers including a first virtual speaker located in a front left direction from a listening point for a listener and a second virtual speaker located in a front right direction from the listening point; and
performing sound field control comprising setting a localization angle formed about the listening point between the first virtual speaker and the second virtual speaker to one of different angles in the localization process.
